(19) United States
(12) Patent Application Publication
(10) Pub. No.: US 2014/0290557 A1
(43) Pub. Date: Oct. 2, 2014

(54) Sports Spectator Officiating Device

(71) Applicants: Paul Hickey, Laurel, MD (US); William Hickey, Laurel, MD (US)

(72) Inventors: Paul Hickey, Laurel, MD (US); William Hickey, Laurel, MD (US)

(21) Appl. No.: 13/851,383

(22) Filed: Mar. 27, 2013

(51) Int. Cl. G09F 17/00

(52) U.S. Cl. CPC G09F 17/00
USPC 116/173

(57) ABSTRACT

This invention relates to a device designed for use by spectators at athletic events wherein a spectator may signal his agreement or disagreement with an official's call by releasing a flag into the air, which flag is tethered to the user's wrist or clothing and therefore retrievable.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention is a novelty device designed for use by a spectator at a sporting event. During the contest, the spectator may express his agreement or disagreement with the play on the field or the sporting official's call by releasing a flag into the air. Because the flag is attached to the user, it can easily be retrieved after it has been thrown.

2. Background of the Invention

The current state of knowledge is as follows. Sporting events have been a popular pastime in America for many years and their popularity continues to grow. Many people choose to attend sporting events as an opportunity for relaxation and to support a local or favorite team. As spectatorship of various sports in person and via television has increased, so has the average familiarity of spectator fans with the rules and regulations of the various sports.

The unofficial standing of each spectator or fan as an amateur official often leads a spectator to experience a desire to communicate his agreement or disagreement with each call made by a referee or umpire. When a player in a contest performs well or scores a goal or point, spectators in attendance express their satisfaction through the clapping of hands, cheering and shouts of approval. When the opposing team is doing well or when frustrated by the quality of the sportsmanship or level of play, vocal noises or hand gestures are used to express the spectating fans' disappointment. The possibility of providing inventions to aid spectator fans in expressing their thoughts and emotions with regards to an official's calls during sporting events has been disclosed in the prior art. Specifically, U.S. Pat. No. 8,197,318 to Miles and U.S. Pat. No. 5,730,443 to Allen disclose devices that allow spectators to simulate the experience of being a game official and try to correctly state the rules infraction being committed, respectively.

Further, U.S. Pat. No. 5,400,437 to Koutras discloses a device allowing spectators in attendance to know when the official has thrown his penalty flag during a football game and more closely follow the game. Spectators can also use apparel-like accessories disclosed in U.S. Pat. No. 6,612,056 to Thomas and U.S. Pat. No. 7,520,074 to Vanova to express their excitement or disapproval during the game.

The problem is that few inventions on the market allow the spectator to unequivocally convey a feeling of outrage or unfairness with respect to a specific rule infraction, especially when it has been missed by the referee in charge. Although U.S. Pat. No. 4,850,052 allows the user to replicate the action of an official throwing a penalty flag, the user of this device must wear a glove that holds the flag within it and use the opposite hand to use the device, which inhibits the wearer's use of both hands during the game.

What is needed is a device that can allow the user to visibly protest or cheer a particular play or missed call by the official during a sporting event while keeping the user's hands unoccupied as well as being easily retrievable once thrown.

### BRIEF SUMMARY OF THE INVENTION

In a preferred embodiment, there is herein provided a sporting spectator penalty flag device comprising: (a) a flag comprising a securing mechanism; (b) a tether comprising a proximal end and a distal end, wherein the proximal end is attached to the flag; and (c) a fastening device attached to the distal end of the tether via an attachment point.

The device as disclosed herein, wherein the flag is comprising of a natural or synthetic material.

The device as disclosed herein, comprising one or more materials taken from the group comprised of: cotton, linen, wool, silk, rayon, nylon, acetate, acrylic, polyester, spandex or any commercially available natural or synthetic equivalent.

The device as disclosed herein, wherein the flag is fashioned in a shape taken from the group comprising: a square, a rectangular, a circle, a triangle, or other known geometric shape.

The device as disclosed herein, wherein the flag is a bright, primary color.

The device as disclosed herein, wherein the flag is fashioned in colors and/or logos of a particular sporting franchise, program or team.

The device as disclosed herein, wherein a weight is attached to the flag.

The device as disclosed herein, wherein the securing mechanism consists of a hole or eyelet punched or cut into the fabric through which the tether can be threaded and secured.

The device as disclosed herein, wherein the securing mechanism is stabilized by attachment of a grommet.

The device as disclosed herein, further comprising wherein the securing mechanism comprises wherein the tether is stitched directly to the flag.

The device as disclosed herein, wherein the securing mechanism comprises a clasp, button, hook, Velcro® strap, or another device of equivalent functionality, allowing attachment to and detachment from to a corresponding mating device on the proximal end of the tether.

The device as disclosed herein, wherein the tether is constructed of one or more materials from the group comprising: string, rope, cord, twine, filament, wire, rubber or the equivalent.

The device as disclosed herein, wherein the tether will be between 1 and 5 feet.

The device as disclosed herein, wherein the fastening device is one of the group comprising: a wrist band, a carabiner, a clip, a hook, a pin, Velcro® strap, clip with a hole, or a similar device of equivalent functionality.

The device as disclosed herein, further comprising an attachment point to which the distal end of the tether is secured.

The attachment point as disclosed herein, comprising a hole, clasp, button, hook, Velcro® strap, or another device of equivalent functionality, allowing attachment to and detachment from a corresponding mating device on the distal end of the tether.

The attachment point as disclosed herein, comprising the use of glue, thread, staples, or pins to secure the distal end of the tether to the fastening device.

The device as disclosed herein, wherein the fastening device is a Velcro® strap and the attachment point comprises wherein the distal end of the tether is sewn directly to the strap.

A method of using the device as claimed herein comprising the steps of throwing the flag into the air, allowing the flag to drop to the ground, and retrieving the flag by retracting the tether.

### BRIEF DESCRIPTION OF THE DRAWINGS

FIG. 1 is a line drawing evidencing the invention with a wristband fastener configuration and no counterweight.

FIG. 2 is a line drawing evidencing the invention with a carabiner fastener configuration and no counterweight.

FIG. 3 is a line drawing evidencing the flag component with 12″×12″ dimensions.

FIG. 4 is a line drawing evidencing the flag component comprising the use of a grommet to secure the tether mechanism to the flag.

FIG. 5 is a line drawing evidencing the flag component comprising the use of stitching to secure the tether mechanism to the flag.

FIG. 6 is line drawing evidencing the tether mechanism secured to a wristband fastening mechanism at its attachment point.

FIG. 7 is a line drawing evidencing the tether mechanism secured to a carabiner fastening mechanism at its attachment point.

### DETAILED DESCRIPTION OF THE INVENTION

The following definitions are provided as an aid to understanding the detailed description of the present invention.

The phrase “securing mechanism” means the mechanism attaching the tether to the flag.

The word “tether” means the tether that connects the flag portion of the device with the fastening device that is attached to the user or user's clothing.

The phrase “fastening device” means the method of attachment of the device to the user's body or clothing.

The phrase “attachment point” refers to the location on the fastening device where the end of the tether is connected.

### Description of the Embodiments

The primary objective of the sports spectator officiating device is to serve as a sporting event novelty which allows the spectator-user to simulate an official or referee's call of a rule infraction during a sporting event such as an American football game. The invention can also produced on a smaller scale as a children's toy as well as used as a novelty item or party favor in a non-sports related setting. For example, it can be used during a business meeting as a lighthearted way of expressing disagreement.

In a preferred embodiment, the sporting spectator penalty flag novelty device comprises a flag with a securing mechanism, a tether with a proximal end attach to the flag securing mechanism and a distal end attached to a fastening device at the attachment point. The flag of this device can be made out of synthetic or natural material such as cotton, linen, wool, silk, rayon, nylon, acetate, acrylic, polyester, spandex or any commercially available natural or synthetic equivalent. The flag can be fashioned into any geometric shape such as a square, a rectangular, a circle, a triangle, or other known geometric shape. The flag can also be of any color and can contain writing on it such as the name or logo of a favorite team or a sponsoring company. In a more preferred embodiment, the flag will be shaped like a square and made of yellow fabric to replicate an American football referee's “penalty flag.” In another preferred embodiment, the flag will be colored and decorated according to the colors and symbols associated with a given sports team, program or franchise.

American football officials use a yellow fabric flag with a counterweight attached to it to aid aerodynamic flight and to allow the official to mark the approximate location of an infraction on the field. In a preferred embodiment, the sporting spectator novelty device will have a weight attached to the flag. In a more preferred embodiment, the weight will be sewn within a fold of the flag. Weighting elements may comprise, by way of example and not limitation, a small sandbag, bag of bird shot or bb's, or any small metal object. Such weighting elements should have a mass sufficient to allow the flag to drop quickly and resist wind, but not so heavy as to cause pain or injury when striking a person. The mass of the weighting element should be between 0.1 to 1.0 ounces.

The flag of the sporting spectator novelty device will have a securing mechanism located on it. This securing mechanism will be used to connect the flag to the proximal end of the tether. In a preferred embodiment, the securing mechanism will consist of a hole or eyelet punched or cut into the fabric through which the tether can be threaded and secured. In a more preferred embodiment, a grommet made of metal or rubber will be used to stabilize the attachment of the tether to the securing mechanism and prevent ripping of the flag fabric by the tether.

In another embodiment, the securing mechanism can comprise a hole, clasp, button, hook, Velcro® strap, or another device of equivalent functionality, allowing attachment to and detachment from a corresponding mating device on the proximal end of the tether. In a more preferred embodiment, any such mechanism could comprise a clasp, hook, Velcro® strap, or carabiner attached to the tether, and used in combination with a grommet or similar stabilizing component attached to the flag.

In another embodiment, the tether can be directly stitched to the flag at the site of the securing mechanism. In a preferred embodiment, the tether will be secured by being sewn directly within the flag, either directly or via a patch.

The proximal end of the tether will be connected to the securing mechanism of the flag while the distal end of the tether will be connected to the fastening device at an attachment point. The use of the tether will allow the user to easily retrieve the flag once it has been thrown by simply pulling on the tether. The user will not have to physically move or change his location to be closer to the flag to pick it up. In a preferred embodiment, the tether will be constructed of one or more materials from the group comprising: string, rope, cord, twine, filament, wire, rubber or the equivalent. The length of the tether preferably will be from 1 to 5 feet.

The fastening device will allow the sporting spectator penalty flag novelty device to be preferably attached on a piece of clothing or an accessory worn by the user in such a manner as to ensure securement but also allow for ease of detachment. The tether can be clipped to the user's belt, pants belt loop, jacket zipper or other clothing. Alternatively, the tether can be attached to a band, bracelet, or Velcro® strap worn around the user's wrist. When not in use, the flag can be held in the hand, or placed within a pants or jacket pocket. This will allow the flag to be easily accessible when ready to throw and prevent the flag from becoming lost. This will also allow the user to have his hands free when not using the invention. Once thrown, having the device attached to the user will allow for it to be easily retrieved.

In a preferred embodiment, the fastening device will be a wrist band, a carabiner, a clip, a hook, a pin, Velcro® strap, clip, or a similar device of equivalent functionality. In a more preferred embodiment, the fastening device will be a Velcro® strap worn as a bracelet, wherein the distal end of the tether is sewn directly to the strap to form the point of attachment.

In another preferred embodiment, the fastening device will be a Velcro® strap worn as a bracelet, wherein the distal end of the tether is sewn to a piece of Velcro® separate from the bracelet strap, which forms the point of attachment to the bracelet strap.

In a preferred embodiment, the fastening device may have an attachment point located on it. The distal end of the tether will connect to the fastening device at this attachment point. In a preferred embodiment, the tether can be secured at the attachment point using a clasp, button, hook, Velcro® strap, or another device of equivalent functionality, allowing attachment to and detachment from a corresponding mating device on the distal end of the tether. In another preferred embodiment, glue, thread, staples, or pins may be used to secure the distal end of the tether to the fastening device.

One method of use of the disclosed device is for a fan at a sporting event who has secured the flag device to his wrist or clothing using a fastening device such as a Velcro strap. The method includes the steps of throwing the flag into the air upon a call made by an official to signify agreement with the call, followed by the steps of allowing the flag to fall and retrieving the flag by retracting the tether. The same steps could be followed to indicate disagreement with an official's non-call when the user views a play which he believes should have drawn an official call.

Another method of use of the disclosed device comprises the same steps, but employed by children in the context of a children's game. Such game could comprise a backyard football game, a driveway basketball game, or any other children's games or play in which “fouls” might be a component.

### DETAILED DESCRIPTION OF THE FIGURES

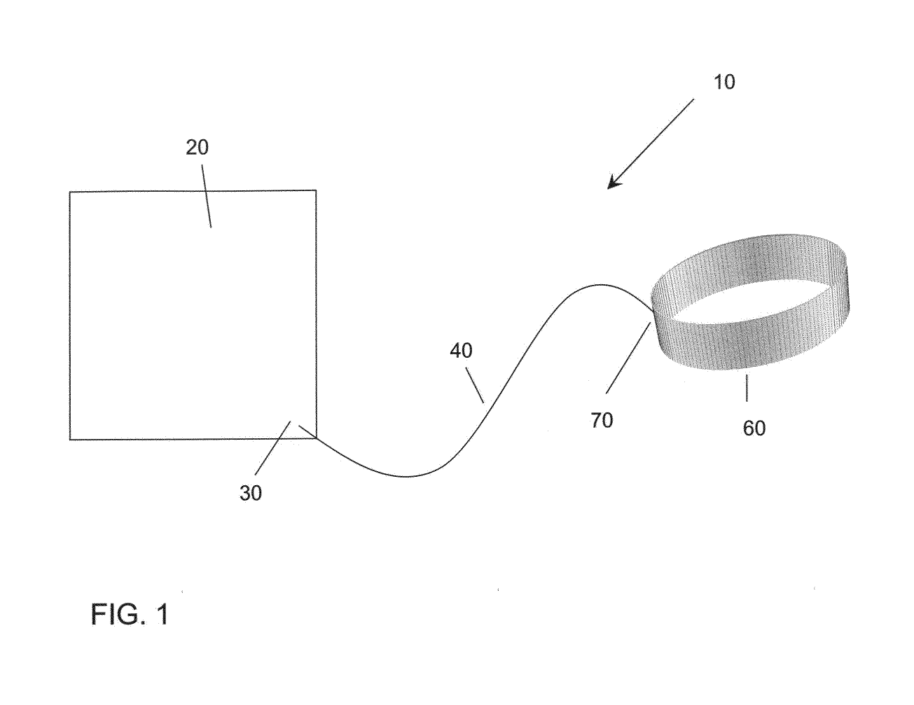

FIG. 1 is a line drawing evidencing the sporting spectator penalty flag device 10 comprising a fabric flag 20 with a securing mechanism 30 attached to the proximal end of tether 40. The distal end of the tether 40 is attached to the fastening device 60, in this case a wristband, at the attachment point 70.

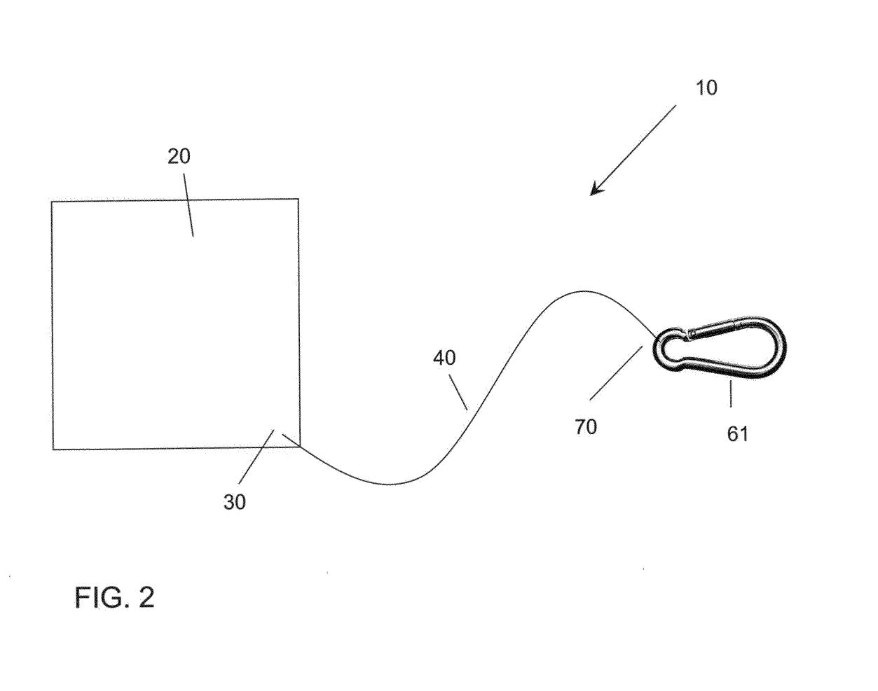

FIG. 2 is a line drawing evidencing the sporting spectator penalty flag device 10 comprising a fabric flag 20 with a securing mechanism 30 attached to the proximal end of tether 40. The distal end of the tether 40 is attached to the fastening device 61, in this case a carabiner, at the attachment point 70.

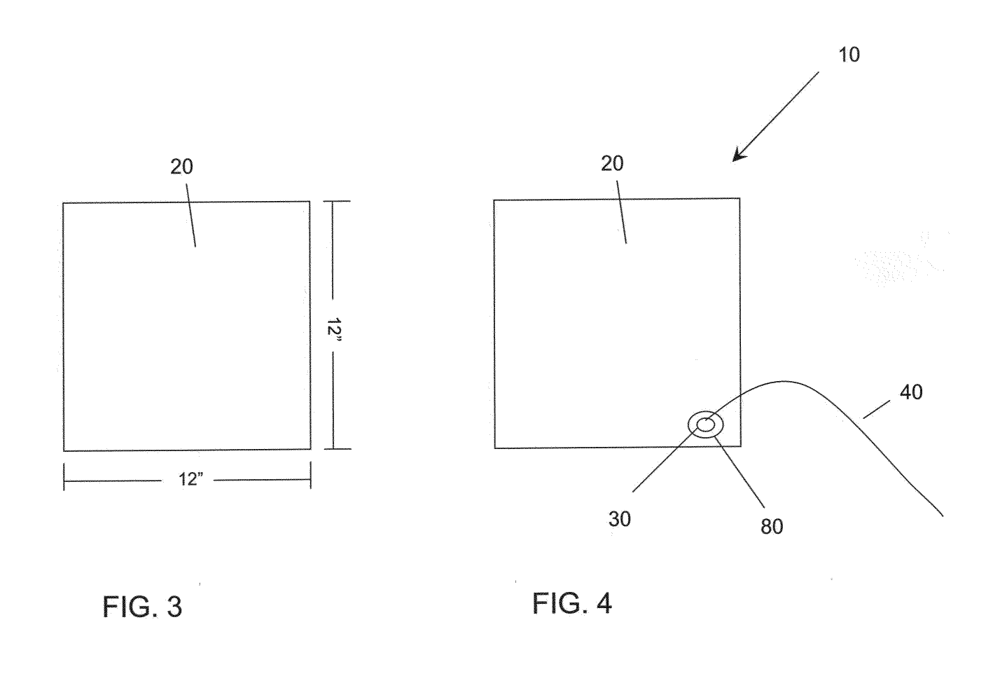

FIG. 3 is a line drawing evidencing fabric flag 20 in a square shape with 12″×12″ dimensions. Other preferred embodiments include dimensions of 6″ by 6″ and 9″×9″.

FIG. 4 is a line drawing evidencing another embodiment of the spectator penalty flag device 10. In FIG. 4, the securing mechanism 30 is a hole punched into the fabric flag 20 material with a rubber or metal grommet 80 used to secure the tether 40.

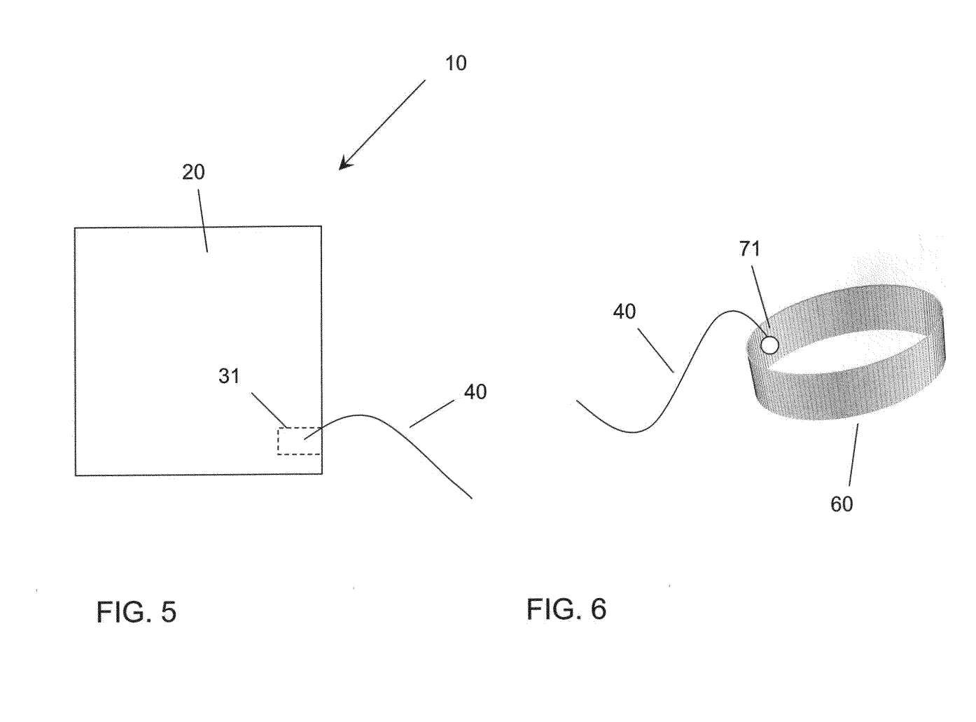

FIG. 5 is a line drawing evidencing another embodiment of the spectator penalty flag device 10, in which, the tether 40 has been stitched into the fabric flag 20 with thread, with such stitching comprising securing mechanism 31.

FIG. 6 is a line drawing evidencing fastening device 60, further comprising attachment point 71. In FIG. 6, the fastening device is a wristband with a punched hole attachment point 71 to which the distal end of the tether 40 is attached by tying.

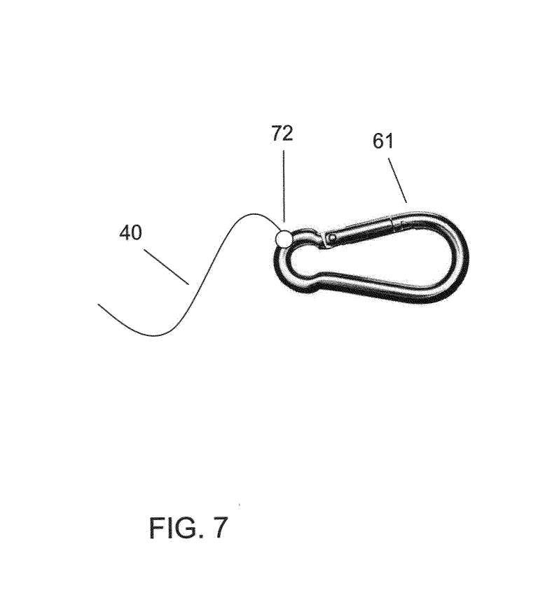

FIG. 7 is a line drawing evidencing another embodiment of the fastening device 61, in this embodiment a carabiner, and the attachment point 72, in this embodiment a metal ring integrated into the fastening device 61, to which the distal end of the tether 40 is secured.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

We claim:

1. A sporting spectator penalty flag device comprising:
a. a flag comprising a securing mechanism;
b. a tether comprising a proximal end and a distal end, wherein the proximal end is attached to the flag; and
c. a fastening device attached to the distal end of the tether via an attachment point.

2. The device of claim 1, wherein the flag is comprising of a natural or synthetic material.

3. The device of claim 2 comprising one or more materials taken from the group comprised of: cotton, linen, wool, silk, rayon, nylon, acetate, acrylic, polyester, spandex or any commercially available natural or synthetic equivalent.

4. The device of claim 1 wherein the flag is fashioned in a shape taken from the group comprising: a square, a rectangular, a circle, a triangle, or other known geometric shape.

5. The device of claim 1, wherein the flag is a bright, primary color.

6. The device of claim 1, wherein the flag is fashioned in colors and/or logos of a particular sporting franchise, program or team.

7. The device of claim 1, wherein a weight is attached to the flag.

8. The device of claim 1, wherein the securing mechanism consists of a hole or eyelet punched or cut into the fabric through which the tether can be threaded and secured.

9. The device of claim 8, wherein the securing mechanism is stabilized by attachment of a grommet.

10. The device of claim 1, further comprising wherein the securing mechanism comprises wherein the tether is stitched directly to the flag.

11. The device of claim 1, wherein the securing mechanism comprises a clasp, button, hook, Velcro® strap, or another device of equivalent functionality, allowing attachment to and detachment from to a corresponding mating device on the proximal end of the tether.

12. The device of claim 1, wherein the tether is constructed of one or more materials from the group comprising: string, rope, cord, twine, filament, wire, rubber or the equivalent.

13. The device of claim 1, wherein the tether will be between 1 and 5 feet.

14. The device of claim 1, wherein the fastening device is one of the group comprising: a wrist band, a carabiner, a clip, a hook, a pin, Velcro® strap, clip with a hole, or a similar device of equivalent functionality.

15. The device of claim 14, further comprising an attachment point to which the distal end of the tether is secured.

16. The attachment point of claim 15, comprising a clasp, button, hook, Velcro® strap, or another device of equivalent functionality, allowing attachment to and detachment from a corresponding mating device on the distal end of the tether.

17. The attachment point of claim 16, comprising the use of glue, thread, staples, or pins to secure the distal end of the tether to the fastening device.

18. The device of claim 1, wherein the fastening device is a Velcro® strap and the attachment point comprises wherein the distal end of the tether is sewn directly to the strap.

19. A method of using the device of claim 1 comprising the steps of throwing the flag into the air, allowing the flag to drop to the ground, and retrieving the flag by retracting the tether.
